(19) United States
(12) Patent Application Publication
(10) Pub. No.: US 2003/0165192 A1
(43) Pub. Date: Sep. 4, 2003

(54) Remote operation method and image transmission method for panning camera

(76) Inventor: Toru Kitta, Yamanashi-ken (JP)

Correspondence Address: KANESAKA AND TAKEUCHI, 1423 Powhatan Street, Alexandria, VA, 22314, US

(21) Appl. No.: 10/376,627

(22) Filed: Mar. 3, 2003

(30) Foreign Application Priority Data
Mar. 4, 2002 (JP) 2002-057444

(51) Int. Cl. H04N 7/12; H04N 11/02

(52) U.S. Cl. 375/240.01; 348/211.11

(57) ABSTRACT

An image transmission method is provided for transmitting compressed image data from a panning camera to a terminal device. The panning camera is connected to a telecommunication line and is capable of being controlled remotely. The terminal device is connected to the telecommunication line, and has an operation device for changing a shooting direction of the panning camera and a display for displaying a still image taken by the camera. In the image transmission method, a compression rate of the compressed image data is increased while the camera is moving to transmit the compressed image. The compression rate returns to a standard rate when the camera stops.

### BACKGROUND OF THE INVENTION AND RELATED ART STATEMENT

The present invention relates to an image transmission method for a system in which a terminal device provided with communication means controls a panning camera located at a specific location away from the terminal device to transmit a still image taken by the camera as image data for displaying on the terminal device.

Conventionally, there is a system in which via a telecommunication line a terminal device such as a cellular telephone remotely controls a panning camera having a photoelectric conversion element such as charge coupled device (CCD) that is capable of changing a shooting direction. In such a system, the panning camera captures and transmits a still image as image data via a telecommunication line to be displayed on the terminal device.

In the system described above, it takes longer time to transmit the image data from the camera when an amount of the still image data becomes larger or a transmission speed of the telecommunication line becomes slower. Here, the transmission speed of the telecommunication line is an amount of data transmitted per unit time. In addition, when the panning camera changes the shooting direction according to a direction from the terminal device, the operation is delayed by an amount of time relating to the transmission speed of the telecommunication line and an amount of time required for changing the shooting direction.

Because of the delay, after remotely operating the camera to change the shooting direction, an operator of the terminal device is required to wait until the image is transmitted to check the shooting direction. In order to obtain the desired shooting direction, the operator is required to repeat this process several times.

With the method described above, after the operator starts to operate the terminal device, it takes long time to obtain the image data taken in the desired shooting direction.

Also, when it takes several seconds to transmit the image data, it is difficult for the operator to determine which input at the terminal device corresponds to which transmitted image, thereby confusing with regard to the desired photographic image.

Furthermore, because the camera moves during the panning, the image taken while panning becomes blurred as a result of shaking of the camera, thus the transmitted image is not suitable for the still image.

Particularly, when the camera zooms in an image from a distance, the image moves faster relative to a shutter speed of the camera, thereby increasing the effect of the shaking of the camera. Also, when the camera takes an image under a dark condition, the shutter speed must be slowed down to obtain enough exposure of the image, thereby increasing the effect of the shaking of the camera.

To solve the aforementioned problems of the prior art, the present invention provides a method of remotely operating a pan camera and efficiently transmitting a desired still image in a short period of time.

Further objects and advantages of the invention will be apparent from the following description of the invention.

### SUMMARY OF THE INVENTION

The present invention provides an image transmission method for transmitting compressed image data from a panning camera to a terminal device. The panning camera is connected to a telecommunication line and is capable of being controlled remotely. The terminal device is connected to the telecommunication line, and has an operation device for changing a shooting direction of the panning camera and a display for displaying a still image taken by the camera. In the image transmission method, a compression rate of the compressed image data is increased while the camera is moving to transmit the compressed image. The compression rate returns to a standard rate when the camera stops.

With the image transmission method, the still image data is transmitted quickly at the higher compression rate just for confirming a shooting direction while the camera is moving and tends to shake. When the desired shooting direction is obtained, the camera stops panning. At that time, the compression rate of the still image data returns to the standard rate, so that a clear image can be obtained. Accordingly, it takes shorter time to obtain the desired image.

According to another aspect of the present invention, an image transmission method is provided for transmitting compressed image data from a panning camera to a terminal device. The panning camera is connected to a telecommunication line and is capable of being controlled remotely. The terminal device is connected to the telecommunication line, and has an operation device for changing a shooting direction of the panning camera and a display for displaying a still image taken by the camera. In a remote operation method according to the present invention, the panning camera is arranged to change the shooting direction by a predetermined angle per one input operation through the operation device. When an operator inputs next operation through the operation device within a predetermined period of time after the previous input, the terminal device resets the time and counts the number of the inputs. Then, after the predetermined period of time, the terminal device sends a direction so that the camera pans or turns the counted number of times. After the panning camera completes the counted number of pans, the still image data is transmitted.

With the remote operation method, it is possible to controls the panning amount of the camera with one operation. After the panning operation is completed, the still image is transmitted. Therefore, it is possible to solve a problem in which it is difficult for an operator to determine which input at the operation device corresponds to which transmitted image.

According to still another aspect of the present invention, an image transmission method is provided for transmitting compressed image data from a panning camera to a terminal device. The panning camera is connected to a telecommunication line and is capable of remote control. The terminal device is connected to the telecommunication line, and has an operation device for controlling a shooting direction of the panning camera, a display for displaying a still image taken by the camera via the telecommunication line and an image request device. In the image transmission method, a compression rate of the compressed image data is increased in a pre-view mode, and returns to a standard rate in an image acquisition mode when the still image data is transmitted.

In a remote operation method according to the present invention, the panning camera is arranged to change the shooting direction by a predetermined angle per one input operation through the operation device. When the operator inputs next operation through the operation device within a predetermined period of time after the previous input, the terminal device resets the time and counts the number of the inputs. Then, after the predetermined period of time, the terminal device sends a direction so that the camera pans or turns the counted number of times. After the panning camera completes the counted number of pans, the still image data is transmitted in the image acquisition mode using the image request device.

With the image transmission method, it is possible to obtain the image in the preview mode while the camera is panning for the desired shooting direction. Also, it is possible to obtain the clear image in the desired shooting direction in the image acquisition mode using the image request device, thereby shortening the amount of time to obtain the desired image.

### BRIEF DESCRIPTION OF THE DRAWINGS

FIG. 1 is an explanatory view showing a configuration of a system according to the present invention;

FIG. 2 is a flowchart of the first embodiment;

FIG. 3 is a flowchart of the second embodiment;

FIG. 4 is a flowchart of the third embodiment;

FIG. 5 is an explanatory view explaining an image transmission method at a standard image compression rate; and

FIG. 6 is an explanatory view explaining an image transmission method at a higher image compression rate.

### DETAILED DESCRIPTION OF PREFERRED EMBODIMENTS

Hereunder, embodiments of the present invention will be explained with reference to the accompanying drawings.

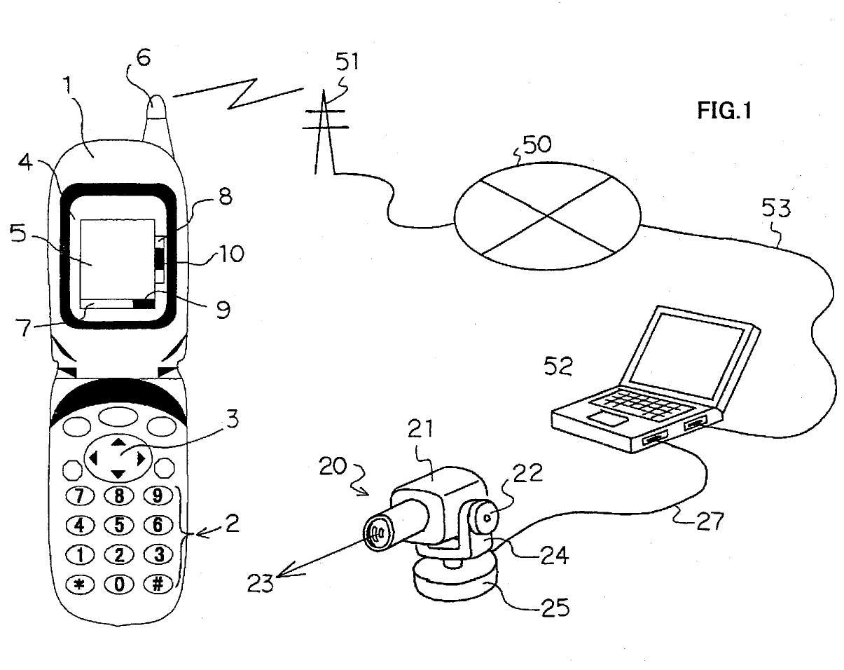

FIG. 1 is an explanatory view showing a system for transmitting image data from a panning camera to a terminal device. The panning camera is located remotely at a specific location and is capable of panning and tilting. The terminal device with a communication device controls the camera to transmit a still image taken by the camera as image data to display on the terminal device.

The panning camera 20 is connected to a network 50 via a personal computer 52 (referred to as PC). A cellular telephone 1 is also connected to the network 50 via a ground based station 51.

The following will describe each of functions of the system in detail. The panning camera 20 changes a shooting direction 23 in a tilt direction (up and down) when a tilt drive motor 22 moves a camera portion 21. The camera portion 21 is rotatably supported on an intermediate support stand 24, and the intermediate support stand 24 is rotatably supported on a support stand 25. A panning drive motor (not shown) disposed in the support stand 25 moves the intermediate support stand 24, thereby changing the shooting direction 23 in a panning direction (left and right).

The camera portion is a device comprising photoelectric conversion elements such as CCD, and outputs a captured image as an image signal. The panning camera 20 sends the image signal to the PC 52 via a communications cable 27.

The PC 52 converts the image signal sent from the panning camera 20 into a digital signal to create image data. The image data is compressed for efficient transmission over the communication line. The compression rate can be altered in the image data compression process.

Also, the PC 52 controls the tilt drive motor 22 and the pan drive motor (not shown) in the panning camera 20 via the communications cable 27. The PC 52 is connected to the network 50 via a communications line 53. The panning camera 20 may be provided with the function of the PC 52.

The following will describe the cellular telephone 1. The cellular phone is provided with a ten-key pad 2, a scroll key 3, a display 4 and an antenna 6.

The ten-key pad 2 and the scroll key 3 are input devices. While they are used as a telephone, the scroll key 3 can also be an input button for the panning operation of the panning camera 20. The ten-key pad 2 also functions as the input buttons for requesting the image data. All of the numerical input buttons have the same function.

The display 4 comprises a liquid crystal display apparatus. The display 4 shows information for a telephone call and the image transmitted from the panning camera. The display 4 also includes an image display area 5. The image is displayed in the image display area 5.

A pan direction scroll bar 7 and a tilt direction scroll bar 8 are displayed at a bottom edge and a right edge of the image display area 5. A pan shooting direction bar 9 is displayed in the pan direction scroll bar 7, and a tilt shooting direction bar 10 is displayed in the tilt direction scroll bar 8.

Both the scroll bars 7 and 8 display the ranges of the shooting directions of the panning camera. The shooting direction bars 9 and 10 indicate current directions of the camera within the range. In the example in FIG. 1, the panning camera is facing a right edge of the range in the pan direction and a center of the range in the tilt direction.

Also, the antenna 6 is provided for wireless communication with the ground based station antenna 51.

The network 50 may be a telephone line or an Internet line. The ground based station antenna 51 is connected to the network 50, so that the cellular telephone 1 can conduct wireless communication with the ground based station antenna 51. Accordingly, it is possible to operate the panning camera 20 from any location, and to display the image taken by the panning camera 20.

While the network 50 may be a telephone line or an Internet line, it is also acceptable to use a dedicated communication cable or a dedicated wireless communication line to connect the terminal device directly with the PC 52 without the public telephone line.

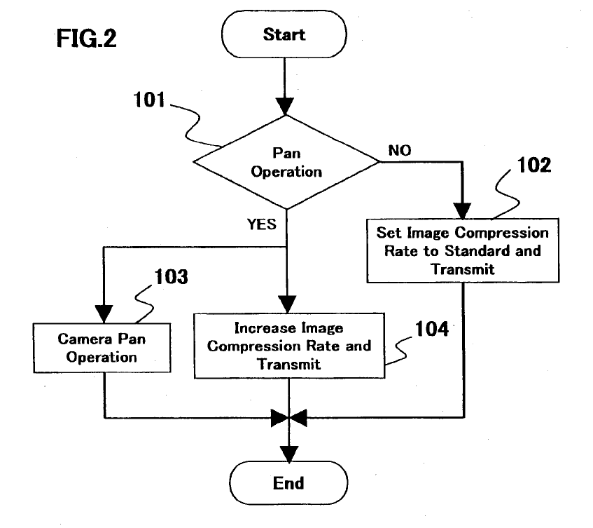

The following will describe three embodiments regarding a method of remotely operating the panning camera using the cellular telephone and a method of transmitting the image from the panning camera to the cellular telephone with reference to the accompanying drawings and flowcharts. Note that in the following flowcharts in FIGS. 2 to 4, the cellular telephone, the PC and the panning camera are powered on and the communication line is connected. A flow from the input operation at the cellular telephone to the panning operation of the panning camera and the image transmission is shown in the flowcharts from start to end thereof.

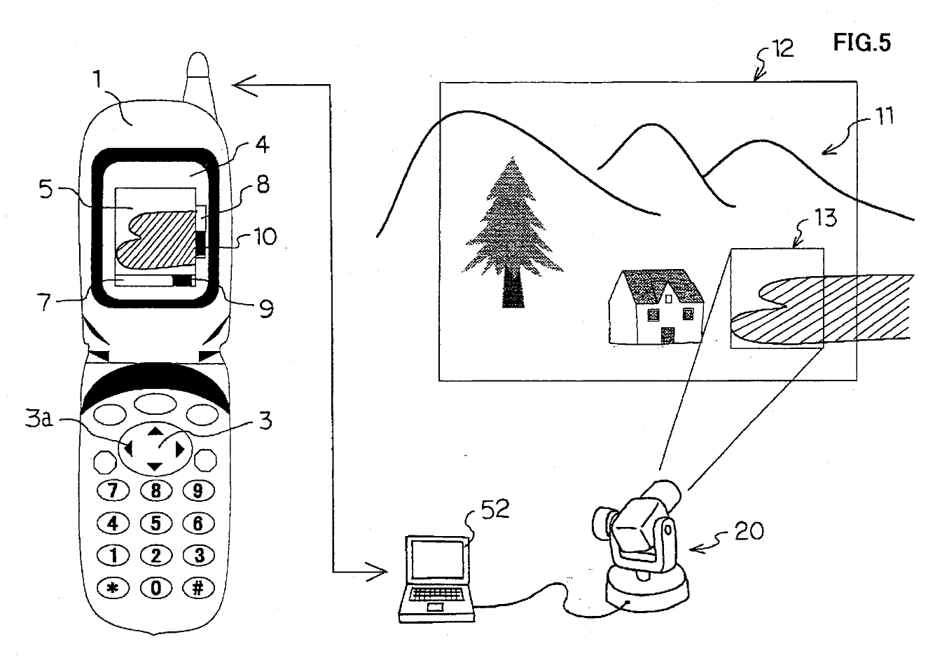

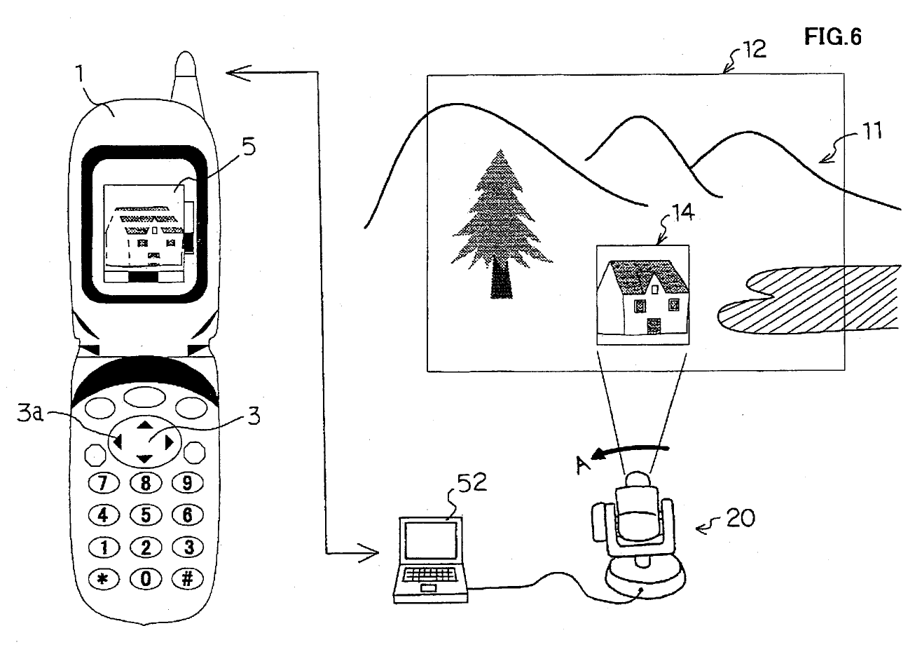

The first embodiment will be described with reference to the flowchart in FIG. 2, and FIGS. 5, 6.

At step 101, the PC 52 determines whether the pan operation is performed through the scroll key 3 on the cellular telephone 1. If it is determined not to be the case, as shown in FIG. 5, the panning camera 20 stops at a shooting area 13 of a scene 11 in the range 12 of the panning and tilting operations, and captures an image of the area 13. The PC 51 converts the captured still image into digital image date, and then compresses the image data at a standard image compression rate to transmit sequentially.

The cellular telephone 1 decompresses the transmitted compressed image data to display the image on a display area of the display 4. The standard image compression rate is set at a level suitable for displaying an image on the display 4 even if the image quality is lowered when decompressed. It is also acceptable to set a compression rate according to a usage and an objective of the still image.

Next, at step 101, if it is determined that the pan operation is performed, for example, a direction 3a on the scroll key 3 is input, at step 103, the PC 52 receives the signal and moves the panning camera 20 in the arrow direction A in FIG. 6.

At step 104, after converting the still image of the area 14 taken while moving into the digital image data, the compression rate is increased. Then, the still image data is transmitted sequentially. The cellular telephone 1 receives the compressed still image data more quickly than the still image data compressed at the standard compression rate with the same communication line speed. Therefore, it is possible to capture a larger amount of still image data while the camera is moving, thereby taking a shorter time to confirm a target object and move the camera in the desired direction.

At this time, the image data compressed at a higher compression rate is transmitted to the cellular telephone 1. Thus, an image quality displayed on the image display area 5 after decompressed is lower than the standard image quality. However, the standard image quality is not necessary because the camera is shaking while moving, thereby reducing the image quality.

Especially, when the camera has an optical system with a long focus distance or the camera with a high magnification zoom lens captures an object in a distance, the camera shaking has a significant effect. This is also the case when it is necessary to use a slow shutter speed to photograph under a dark lighting condition.

The image compression rate may be increased to a degree where it is possible to confirm an object in the photograph.

When the panning camera movement is completed, steps 101 and 102 are repeated. Therefore, the image data compressed at the standard rate is transmitted, and a clear image is displayed on the display field of the cellular phone.

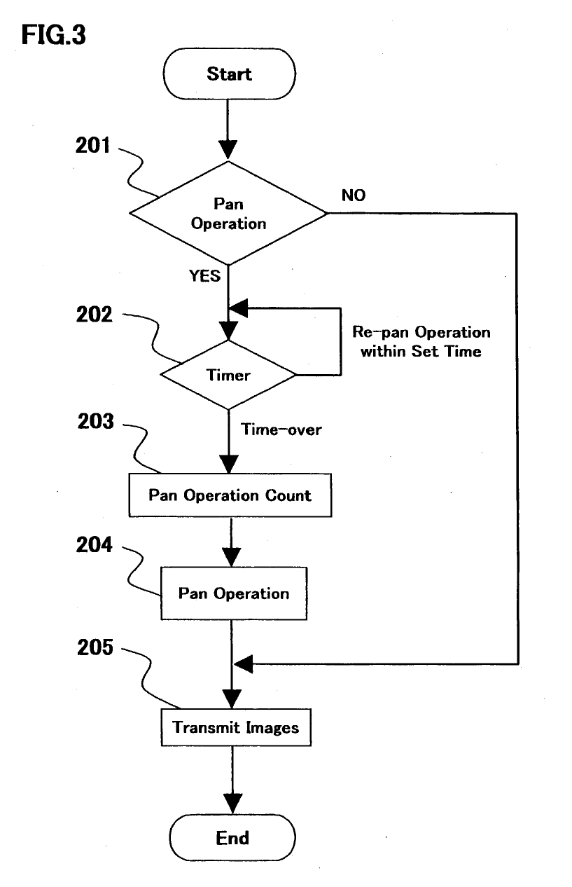

The second embodiment will be explained with reference to the flowchart in FIG. 3 and FIG. 5. At step 201, when the PC 52 determines that there is no panning or tilting operation, there is no input through the scroll key 3. At step 205, a still image in the shooting direction at that moment is transmitted.

At step 201, when it is determined that there is a panning or tilting operation, for example, there is an input through 3a of the scroll key 3 in FIG. 5, a timer in the cellular telephone starts at step 202. Whenever there is an input through the scroll key 3 within a predetermined period of time, the timer is reset. This process is repeated until there is no further input through the scroll key 3 and the timer reaches the predetermined period of time.

At step 203, the number of input through the scroll key 3 for the panning and tilting operation is counted until the time limit is up at step 202. The cellular telephone 1 sends a signal indicating the number of the panning and tilting operations corresponding to the number of the input. Further, an amount of an angle change in the shooting direction per one operation of the panning camera 20 is predetermined. Thus, whenever there is an input through the scroll key 3, the shooting direction bars 9 and 10 located in the scroll bars 7 and 8 are moved to display a position corresponding to the position where the movement of the panning camera is completed.

Then, at step 204, since the amount of the angle change in the shooting direction is predetermined per one operation of the panning camera 20, the panning camera 20 changes its angle according to the number of the inputs for panning or tilting the panning camera. At step 205, the still images in the shooting directions where the panning camera is moved are transmitted.

With this configuration, it is possible to control the operation of the panning camera through one transmission and to display the final position of the panning camera in advance. The still images are transmitted after the panning or tilting operations, thereby confirming the shooting directions and the images regardless of the speed of the communications line.

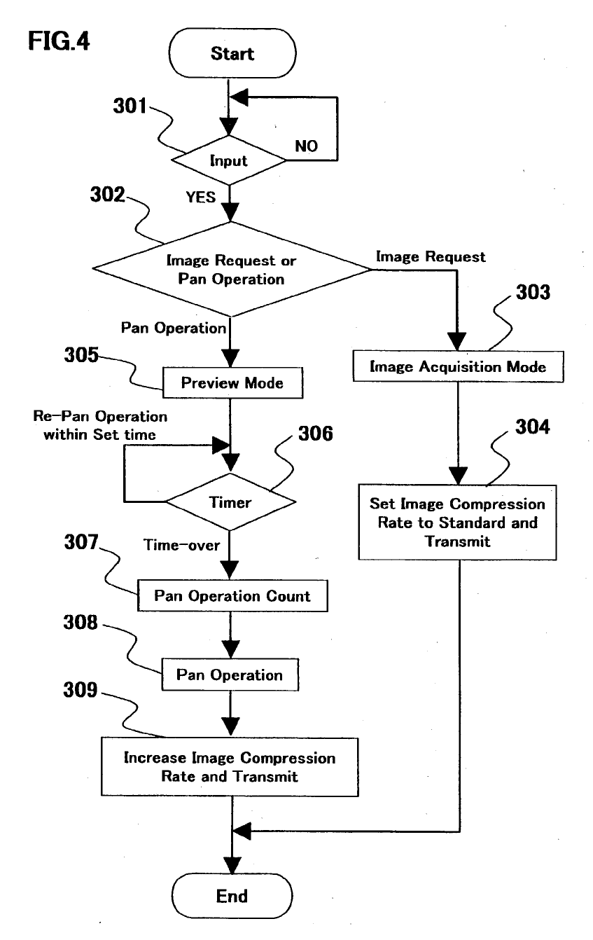

The third embodiment will be explained according to the flowchart in FIG. 4. At step 301, it is determined whether there is an image request through the ten-key pad 2 on the cellular telephone 1, or there is an operational input of the panning camera through the scroll key 3. If there is no input, the step is repeated. That is, the image transmitted before the step is still displayed on the cellular telephone 1.

When there is an input, it proceeds to step 302. When there is the image request through the ten-key pad 2, the image acquisition mode signal at step 303 is sent from the cellular telephone 1 to the PC 52. At step 304, the PC 52 receives the signal, converts the still image in the shooting direction from the panning camera at that moment to the digital image data, then compresses the image data at the standard image compression rate for transmission.

When there is the operational input of the panning camera through the scroll key 3 at step 301, the preview mode at step 305 is activated and the timer in the cellular telephone starts at step 306. Whenever there is an input through the scroll key 3 within a set amount of time, the timer is reset. This process is repeated until there is no further input through the scroll key 3 and the timer reaches its timeout.

At step 307, the number of inputs for the panning operation through the scroll key 3 is counted until the time limit is up at step 306. The cellular telephone 1 sends the panning and tilting signal corresponding to the number of the inputs.

Furthermore, the amount of the angle change in the shooting direction per one operation of the panning camera 20 is predetermined. Thus, whenever there is the input through the scroll key 3, the shooting direction bars 9 and 10 located in the scroll bars 7 and 8 move to display a position corresponding to the position where the movement of the panning camera is completed.

Then, at step 308, because the amount of the angle change in the shooting direction per one input of the panning camera 20 is set, the panning camera 20 changes its angle according to the number of the operational inputs for panning or tilting the camera.

At step 309, after the camera stops panning, the PC 52 converts the still images in the shooting directions from the panning camera to the digital image data, and then increases the image compression rate for transmission.

With this configuration, it is possible to control the operation of the panning camera through one transmission and to display the final position of the panning camera in advance. The still images are transmitted after the panning or tilting operation, thereby confirming the shooting directions and the images regardless of the speed of the communications line.

Further, with the image transmission method, it is possible to obtain the image in the preview mode while the camera is panning for the desired shooting direction. Also, it is possible to obtain the clear image in the desired shooting direction in the image acquisition mode using the image request device, thereby shortening the amount of time to obtain the desired image.

While the invention has been explained with reference to the specific embodiments of the invention, the explanation is illustrative and the invention is limited only by the appended claims.

What is claimed is:

1. An image transmission method for transmitting image data, comprising:
moving a panning camera for capturing image data by actuating operation means of a terminal device located away from the camera and connected through a communication line,
compressing the image data at a first compression rate when the panning camera stops, and compressing the image data at a second compression rate higher than the first compression rate when the panning camera is moving, and
transmitting the compressed image data sequentially at the first and second compression rates to display means of the terminal device to show still images with different modes.

2. An image transmission method according to claim 1, wherein said compressed image data is wirelessly transmitted to the terminal device.

3. An image transmission method according to claim 2, wherein a cellular phone controls the camera and displays the image data as the terminal device.

4. A remote control operating method for transmitting image data, comprising:
setting a panning angle of a panning camera for one panning operation,
inputting a number of the panning operations through a terminal device located away from the panning camera and
connected thereto through a communication line,
moving the panning camera for capturing image data for angles corresponding to the number of the panning operations input to the terminal device after completion of inputting the number of the panning operations, and
transmitting the image data sequentially to display means of the terminal device to show still images after completion of moving the panning camera.

5. A remote control operating method according to claim 4, wherein one panning operation is set by pushing one key in the terminal device within a predetermined time; an additional panning operation is set by pushing said one key within the predetermined time; and said number of the panning operations is determined by a number of pushing of the one key.

6. A remote control operating method according to claim 4, wherein said panning camera moves for the number of the panning operations, and takes still images, which are transferred to the display means.

7. A remote control operating method according to claim 6, wherein an angle of each still image is displayed in the terminal device.

8. A remote control operating method according to claim 7, wherein a direction of the panning camera is displayed in the terminal device when the number of panning operations is input.

9. An image transmission method according to claim 4, wherein a cellular phone controls the camera and displays the image data as the terminal device.

10. An image transmission method according to claim 4, further comprising providing a first compression rate for compressing the image data and a second compression rate for compressing the image data higher than the first compression rate, said image data at the panning operation being processed by the first compression rate and transmitted to the display means.

11. An image transmission method according to claim 10, further comprising pushing an image request so that the image data is processed at the second compression rate and displayed at the display means.
